(19) United States
(12) Patent Application Publication
(10) Pub. No.: US 2019/0019626 A1
(43) Pub. Date: Jan. 17, 2019

(54) POLYMER COMPOSITE MATERIAL FOR SOLID CAPACITOR, CAPACITOR PACKAGE STRUCTURE USING THE SAME AND MANUFACTURING METHOD THEREOF

(71) Applicant: APAQ TECHNOLOGY CO., LTD., Miaoli County (TW)

(72) Inventors: CHIEH LIN, Hsinchu County (TW); MING-TSUNG CHEN, Changhua County (TW)

(21) Appl. No.: 15/833,018

(22) Filed: Dec. 6, 2017

(30) Foreign Application Priority Data
Jul. 12, 2017 (TW) 106123353

(51) Int. Cl. H01G 9/042; C08G 61/12; H01G 9/012; H01G 9/00; H01G 9/15; H01G 9/10

(52) U.S. Cl. CPC H01G 9/0425; C08G 61/126; H01G 9/012; H01G 9/0032; C08G 2261/1424; H01G 9/10; C08G 2261/18; C08G 2261/3223; H01G 9/15

(57) ABSTRACT

The instant disclosure provides a polymer composite material applied to a solid capacitor, a capacitor package structure using the same and a manufacturing method thereof. The method includes adding an emulsifier, 3,4-ethylenedioxythiophene and poly(styrenesulfonate) into a solvent to form a mixture solution; and initiating the polymerization reaction between the emulsifier, 3,4-ethylenedioxythiophene and poly(styrenesulfonate) for forming the polymer composite material.

### BACKGROUND

### 1. Technical Field

The instant disclosure relates to a polymer composite material and a method for manufacturing the same, and in particular, to a polymer composite material for a solid capacitor and a method for manufacturing the same.

### 2. Description of Related Art

Capacitors are widely used in consumer appliances, computers, power supplies, communication products and vehicles, and hence, are important elements for electronic devices. The main effects of the capacitors are filtering, bypassing, rectification, coupling, decoupling and phase inverting, etc. Based on different materials and uses thereof, capacitors can be categorized into aluminum electrolytic capacitors, tantalum electrolytic capacitors, laminated ceramic capacitors and thin film capacitors. In the existing art, solid electrolytic capacitors have the advantages of small size, large capacitance and excellent frequency property and can be used in the decoupling of the power circuits of central processing units. Solid electrolytic capacitors use solid electrolytes instead of liquid electrolytic solutions as cathodes. Conductive polymers are suitable for the cathode material of the capacitors due to its high conductivity, and the manufacturing process using conductive polymers is simple and low cost.

Conductive polymers that are suitable for the cathode of solid capacitors include polyaniline (PAni), polypyrrole (PPy), polythiophene (PTh) and their derivatives. The PEDOT:PSS (poly(3,4-ethylenedioxythiophene)) composite has relatively high conductivity and lower polymerization rate than other polymers such as PAni and PPy, and hence, can be easily prepared under room temperature by polymerization processes. In addition, the PEDOT:PSS composite has better weather resistance and thermal resistance. The other advantages of the PEDOT:PSS composite include good dispersing property, low production cost, high transparency and excellent processability. Therefore, using a PEDOT:PSS composite as a component for forming the conductive polymer layer on the cathode of the capacitor is beneficial to the electrical property of the capacitor.

One crucial factor related to the use of the PEDOT:PSS composite during its manufacturing process is the impregnation (dipping) rate (coverage rate/covering rate) of the PEDOT:PSS composite towards the cathode portion of the capacitor. The solid electrolyte formed by the conductive polymer such as PEDOT:PSS composite should be disposed in the corrosion voids or holes on the surface of the electrode for increasing the impregnation rate of the conductive polymer, thereby increasing the capacitance of the capacitor. Therefore, the particle size of the conductive polymer for forming the solid electrolyte such as PEDOT:PSS composite should be reduced for enabling the composite material to enter or fill the voids or holes easily.

Accordingly, in the technical field of the instant disclosure, there is a need to improve the electrical performance of the solid electrolytic capacitor package structures.

### SUMMARY

An embodiment of the instant disclosure provides a method for manufacturing a polymer composite material for a solid capacitor comprising: adding an emulsifier, 3,4-ethylenedioxythiophene and poly(styrenesulfonate) into a solvent to form a mixture solution; and initiating a chemical reaction between the emulsifier, 3,4-ethylenedioxythiophene and poly(styrenesulfonate) for forming the polymer composite material.

Another embodiment of the instant disclosure provides a method for manufacturing a capacitor package structure including providing at least a capacitor having a cathode portion using the polymer composite material manufactured mentioned above, and packaging the capacitor by a packaging structure, wherein a positive pin and a negative pin both electrically connected to the capacitor are exposed from the packaging structure.

Yet another embodiment of the instant disclosure provides a polymer composite material for a cathode portion of a capacitor, wherein the polymer composite material includes 3,4-ethylenedioxythiophene, poly(styrenesulfonate) and an emulsifier, wherein the emulsifier encloses 3,4-ethylenedioxythiophene and poly(styrenesulfonate).

Another embodiment of the instant disclosure provides a capacitor package structure including at least a capacitor, wherein a cathode portion of the capacitor employs the polymer composite material mentioned above.

The instant disclosure including the technical features of “the polymer composite material including 3,4-ethylenedioxythiophene, poly(styrenesulfonate) and an emulsifier” can effectively increase the dispersing property of the polymer composite material in a solvent, thereby reducing the particle size of the polymer composite material. Therefore, compared to the PEDOT:PSS composite in the existing art, the polymer composite material of the instant disclosure can fill into the corrosion holes on the surface of the electrodes, thereby increasing the capacitance of the capacitor and improving the overall electrical property of the capacitor.

In addition, the emulsifier is included as a component for preparing the polymer composite material, and hence, the polymer composite material has excellent dispersing property in the solvent and employing mechanical-force-driven stirring is unnecessary for the mixture solution during the preparation of the polymer composite material. Accordingly, the complexity and the manufacturing cost of the manufacturing process are reduced.

In order to further understand the techniques, means and effects of the instant disclosure, the following detailed descriptions and appended drawings are hereby referred to, such that, and through which, the purposes, features and aspects of the instant disclosure can be thoroughly and concretely appreciated; however, the appended drawings are merely provided for reference and illustration, without any intention to be used for limiting the instant disclosure.

### BRIEF DESCRIPTION OF THE DRAWINGS

The accompanying drawings are included to provide a further understanding of the instant disclosure, and are incorporated in and constitute a part of this specification. The drawings illustrate exemplary embodiments of the instant disclosure and, together with the description, serve to explain the principles of the instant disclosure.

FIG. 1 is a sectional schematic view of a capacitor employing the polymer composite material provided by the embodiments of the instant disclosure.

FIG. 2 is a sectional schematic view of a capacitor package structure provided by the embodiments of the instant disclosure.

FIG. 3 is a three-dimensional schematic view of another capacitor employing the polymer composite material provided by the embodiments of the instant disclosure.

FIG. 4 is a sectional schematic view of another capacitor package structure provided by the embodiments of the instant disclosure.

FIG. 5 is a flow chart of a method for manufacturing a polymer composite material for a solid capacitor provided by an embodiment of the instant disclosure.

FIG. 6 is a flow chart of a method for manufacturing a polymer composite material for a solid capacitor provided by another embodiment of the instant disclosure.

FIG. 7 is a structural schematic view of a polymer composite material for a solid capacitor provided by an embodiment of the instant disclosure.

FIG. 8 is a structural schematic view of a polymer composite material for a solid capacitor provided by another embodiment of the instant disclosure.

### DESCRIPTION OF THE EXEMPLARY EMBODIMENTS

Reference will now be made in detail to the exemplary embodiments of the instant disclosure, examples of which are illustrated in the accompanying drawings. Wherever possible, the same reference numbers are used in the drawings and the description to refer to the same or like parts.

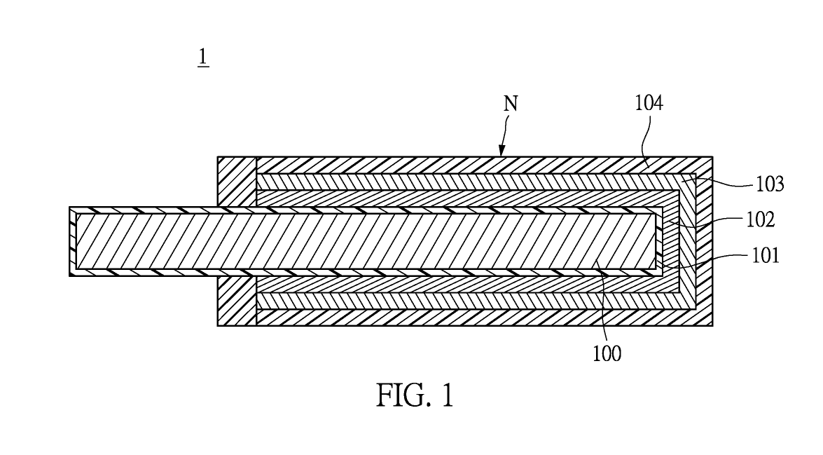

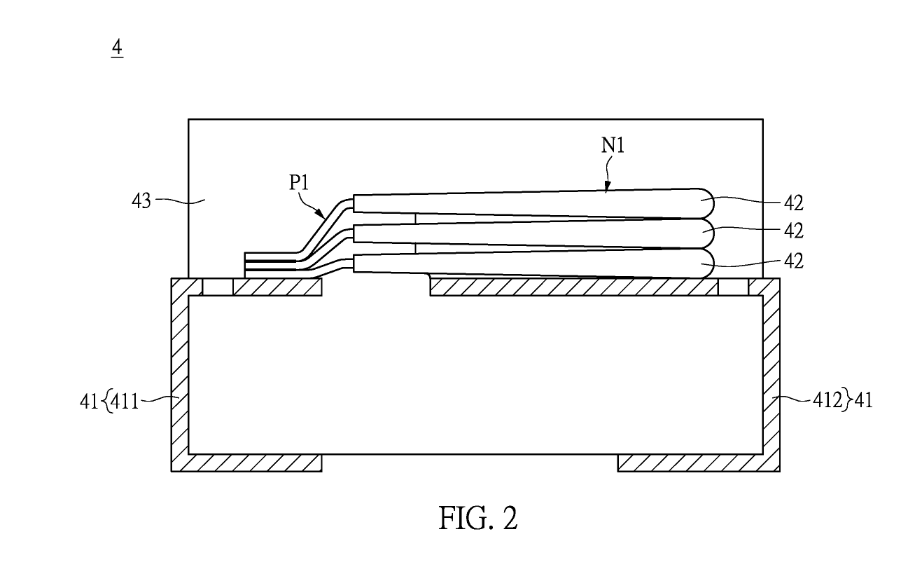

Reference is made to FIG. 1 and FIG. 2. Specifically, a polymer composite material 2 provided by the instant disclosure can be applied to a conductive polymer layer 102 of the cathode portion N of a capacitor 1. In FIG. 2, the capacitor 1 is a capacitor unit 42 in a stacked type solid electrolytic capacitor 4.

For example, as shown in FIG. 1, the capacitor 1 can include a metal foil 100, an oxidation layer 101 covering the metal foil 100, a conductive polymer layer 102 covering (enclosing) a part of the oxidation layer 101, a carbon paste layer 103 covering the conductive polymer layer 102 and a silver paste layer 104 covering the carbon paste layer 103. The structure of the capacitor 1 can be adjusted based on actual needs. The conductive polymer layer 102 is used as the solid electrolyte of the capacitor 1.

As shown in FIG. 2, the stacked type solid electrolytic capacitor 4 includes a plurality of capacitor units 42 stacked sequentially. In addition, the stacked type solid electrolytic capacitor 4 includes a conductive frame 41. The conductive frame 41 includes a first conductive terminal 411 and a second conductive terminal 412 separated from the first conductive terminal 411 for a predetermined distance. The capacitor units 42 stacked sequentially and electrically connected to each other have a first positive electrode portion P1 connected to the first conductive terminal 411 of the conductive frame 41 corresponding thereto, and a first negative electrode portion N1 connected to the first conductive terminal 411 of the conductive frame 41 corresponding thereto. In addition, a packaging gel 43 can be used to enclose the plurality capacitor units 42 for forming the stacked type solid electrolytic capacitor 4.

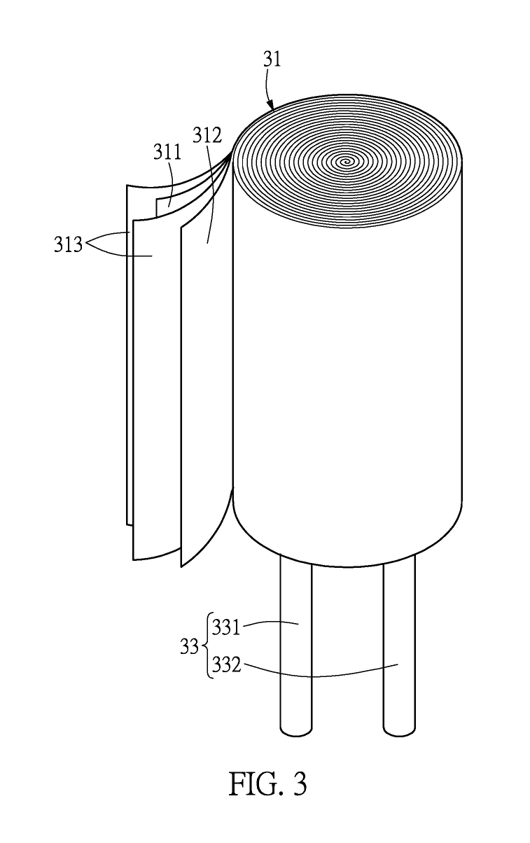

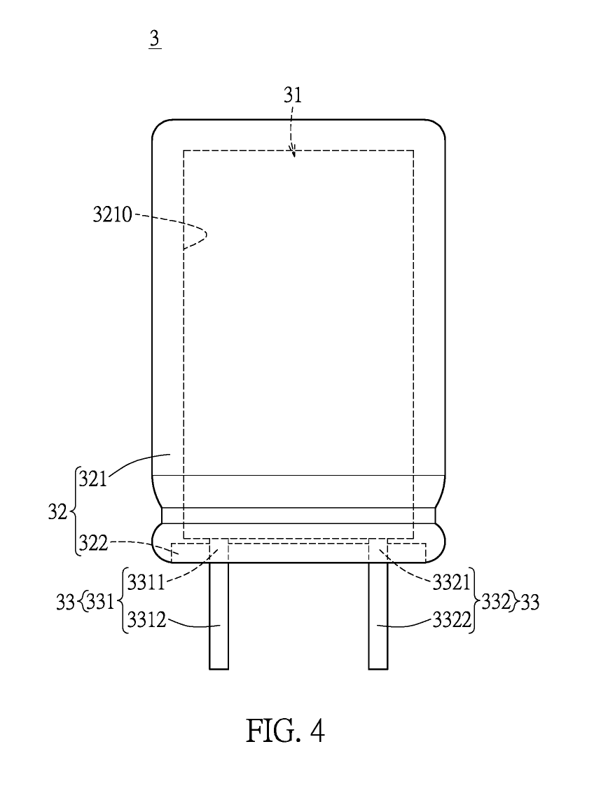

Reference is made to FIG. 3 and FIG. 4. In another embodiment, the capacitor 1 is the capacitor unit in the winding-type solid state electrolytic capacitor 3.

As shown in FIG. 4, the winding-type solid state electrolytic capacitor 3 includes a winding-type component 31, a packaging component 32 and a conductive component 33. Referring to FIG. 3, the winding-type component 31 includes a winding-type positive conductive foil 311, a winding-type negative conductive foil 312 and two winding-type isolating foils 313. In addition, one of the two winding-type isolating foils 313 is disposed between the winding-type positive conductive foil 311 and the winding-type negative conductive foil 312, and one of the winding-type positive conductive foils 311 and the winding-type negative conductive foil 312 is disposed between the two winding-type isolating foils 313. The winding-type isolating foils 313 can be isolation papers or a paper foils having the polymer composite material 2 provided by the instant disclosure formed thereon by an immersion process.

As shown in FIG. 4, the winding-type component 31 is enclosed in the packaging component 32. For example, the packaging component 32 includes a capacitor casing structure 321 (such as an aluminum case or other metal cases) and a bottom end sealing structure 322. The capacitor casing structure 321 has an accommodating space 3210 for accommodating the winding-type component 31, and the bottom end sealing structure 322 is disposed at the bottom of the capacitor casing structure 321 for sealing the accommodating space 3120. In addition, the packaging component 332 can be a packaging body formed by any insulation material.

The conductive component 33 includes a first conductive pin 331 electrically contacting the winding-type positive conductive foil 311 and a second conductive pin 332 electrically contacting the winding-type negative conductive foil 312. For example, the first conductive pin 331 has a first embedded portion 3311 enclosed in the packaging component 32 and a first exposed portion 3312 exposed from the packaging component 32, and the second conductive pin 332 has a second embedded portion 3321 enclosed in the packaging component 32 and a second exposed portion 3322 exposed from the packaging component 32.

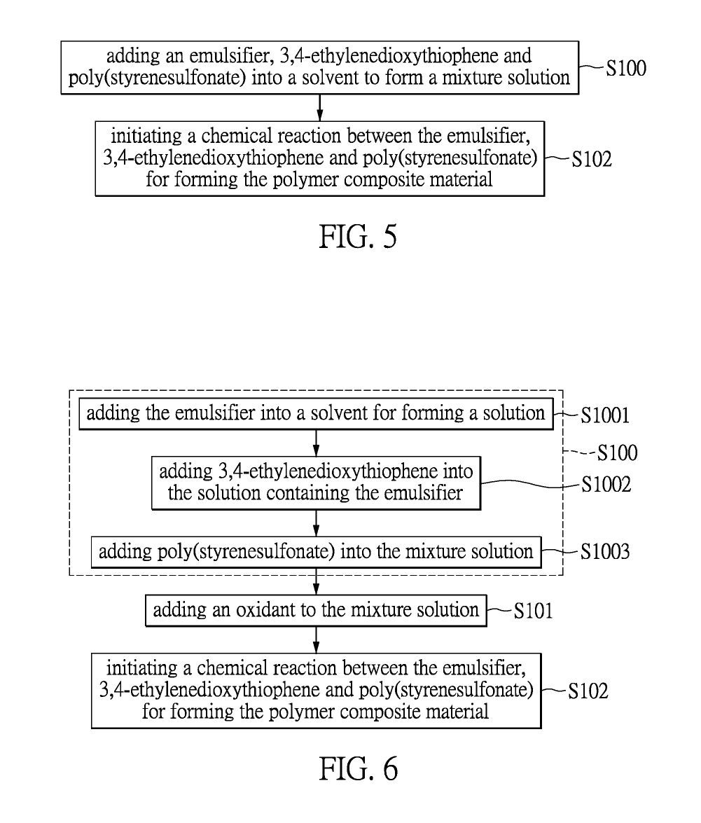

Reference is made to FIG. 5 and FIG. 6. As shown in FIG. 5, the method for manufacturing the polymer composite material for solid capacitor includes the following steps: adding an emulsifier, 3,4-ethylenedioxythiophene and poly(styrenesulfonate) into a solvent to form a mixture solution (step S100), and initiating a chemical reaction between the emulsifier, 3,4-ethylenedioxythiophene and poly(styrenesulfonate) for forming the polymer composite material (step S102).

Specifically, an emulsifier 21, 3,4-ethylenedioxythiophene (EDOT) and poly(styrenesulfonate) (PSS) are added into a solvent. For example, the emulsifier 21 can be selected from a group consisting of the following compounds: a polyol, hexadecyl trimethyl ammonium bromide, cetyltrimethylammonium bromide, dodecyltrimethylammonium bromide, polyethylene glycol monostearate, sodium dodecyl sulfate, sodium dodecylbenzenesulfonate, oleic acid and the derivatives thereof, glycerol monostearate, polyoxyethylene monooleate, poly(oxyethylene) (10) oleyl alcohol ether, sorbitan monolaurate, sorbitan monopalmitate, sorbitan monostearate, sorbitan tristearate, sorbiatan monooleate, sorbitan sesquiolate, sorbitan tribleate, polyoxyethylene oxypropylene oleate, polyoxyethylene sorbitol hexastearate, polyoxyethylene esters of mixed fatty acid and resin acids, polyoxyethylene sorbitol lanolin derivative, polyoxyethylene alkyl aryl ether, polyoxyethylene sorbitol beeswax derivative, polyoxyethylene monopalmitate, polyoxyethylene glycol monopalmitate, polyoxyethylene oxypropylene oleate, tetraethylene glycol monolaurate, polyoxyethylene monolaurate, polyoxyethylene lauryl ether, polyoxyethylene enemonooleate, hoxaethylene glycol monostearate, propylene glycol fatty acid ester, polyoxyethylene oxypropylene stearate, N-cetyl N-ethyl morpholinium ethosulfate, alkyl aryl sulfonate, polyoxypropylene stearate, polyoxyethylene laurylether, polyoxyethylene stearyl alcohol, diethylene glycol monolaurate, sorbitan monolaurate, sorbitan monopalmitate, ethylene glycol diglycidyl ether, polyethylene glycol diglycidyl ether, propanediol diglycidyl ether, polypropanediol diglycidyl ether, 1,2,3-propanetriol glycidyl ethers, and butanediol diglycidyl ether. Preferably, the emulsifier 21 is a polyol. More preferably, the emulsifier 21 is D-sorbital, polyethylene glycol or polypropylene glycol. It should be noted that in the instant disclosure, the materials with the function of surfactant can be used as the emulsifier 21, and the type and species of the emulsifier 21 are not limited thereto. In addition, emulsifiers of different species can be used at the same time. The solvent can be water or an organic solvent such as ethanol.

The 3,4-ethylenedioxythiophene (EDOT) is an reactant for undergoing a polymerization process and forming (poly(3,4-ethylenedioxythiophene):polystyrene composite (PEDOT:PSS) 22. Specifically, the PEDOT:PSS composite 22 is a mixture formed by two ionomers. The two ionomers are sodium polystyrene sulfonate which is a sulfonated polyethylene, and poly(3,4-ethylenedioxythiophene) which is a conjugated polymer based on polythiophene. The two ionomers form a macromolecular salts, which is referred to as the PEDOT:PSS composite 22 in the instant disclosure.

It should be mentioned that in step S100, the order of the additions of the emulsifier 21 and the 3,4-ethylenedioxythiophene is not limited in the instant disclosure. In other words, the emulsifier 21 can be added into the solvent for forming a solution before 3,4-ethylenedioxythiophene is added into the solution containing the emulsifier 21. In another embodiment, 3,4-ethylenedioxythiophene is first added into the solvent for forming a solution, then the emulsifier 21 is added into the solution containing 3,4-ethylenedioxythiophene. In another embodiment, the emulsifier 21 and 3,4-ethylenedioxythiophene are added into the solvent at the same time. As shown in FIG. 6, in an embodiment of the instant disclosure, the emulsifier 21 is first added into the solvent for forming a solution (step S1001), then 3,4-ethylenedioxythiophene is added into the solution containing the emulsifier 21 (step S1002). Lastly, the polystyrene (PSS) is added into the mixture solution (step S1003).

In the preparing process of the PEDOT:PSS composite 22 in the existing art, if 3,4-ethylenedioxythiophene is added into the solvent (such as water or ethanol) separately (without adding emulsifiers), 3,4-ethylenedioxythiophene will form small liquid drops in the solvent, and hence, the solution formed therefrom has an opaque appearance and is in a milky-white state. The formation of an opaque solution indicates that the 3,4-ethylenedioxythiophene liquid drops in ethanol have a relatively large particle size. In order to improve the dispersing property of 3,4-ethylenedioxythiophene in ethanol, the emulsifier 21 is added before the polymerization process in the instant disclosure. Therefore, after performing step S1002 in the method for manufacturing the polymer composite material for solid capacitor provided by the instant disclosure, the mixture solution formed by the emulsifier 21, 3,4-ethylenedioxythiophene and the solvent has a semi-transparent or transparent (clear) appearance. The formation of such a mixture solution indicates that the particle size of each of the 3,4-ethylenedioxythiophene liquid drops in the mixture solution is significantly reduced.

It should be noted that in the instant disclosure, in the step of adding the emulsifier 21 (step S1001), the emulsifier 21 is presented in the mixture solution in an amount of 0.1 to 30 weight %. In another embodiment, the weight ratio between the emulsifier 21 and 3,4-ethylenedioxythiophene is ranging from 1:10 to 10:1. For example, the ratio between the emulsifier 21 and the 3,4-ethylenedioxythiophene is 1:1. The amount of the PEDOT:PSS composite 22 in the above range can satisfy the dispersing effect without producing any negative effect on the obtained polymer composite material 2.

By virtue of the emulsifier, mechanical-force-driven stirring equipment, such as stir bars or homogenizers, is not necessary for the reaction process of the instant disclosure. However, the mechanical stirring equipment can still be used for accelerating the reaction process.

In step S102, the chemical reaction between 3,4-ethylenedioxythiophene, polystyrene sulfonate and the emulsifier 21 is initiated for forming the polymer composite material 2.

Specifically, an oxidant can be added before step S102 for initiating the reaction between 3,4-ethylenedioxythiophene and polystyrene sulfonate. As shown in FIG. 6, before the step of initiating the reaction between 3,4-ethylenedioxythiophene and polystyrene sulfonate, a step for adding one or more oxidants into the mixture solution is included (step S101). For example, the oxidant can be sodium persulfate or potassium persulfate. However, the instant disclosure is not limited thereto.

Referring to FIG. 5 and FIG. 6, in step S102, the reaction temperature of the polymerization system can be adjusted, and a stirring device can be used for accelerating the reaction. After the polymerization reaction is completed, the polymer composite material 2 can be obtained. The time of the polymerization reaction can be in the range of several minutes to 30 hours. However, the time of the polymerization reaction is determined based on the reaction temperature, the species of the oxidant and the amount of 3,4-ethylenedioxythiophene and polystyrene sulfonate, and is not limited in the instant disclosure.

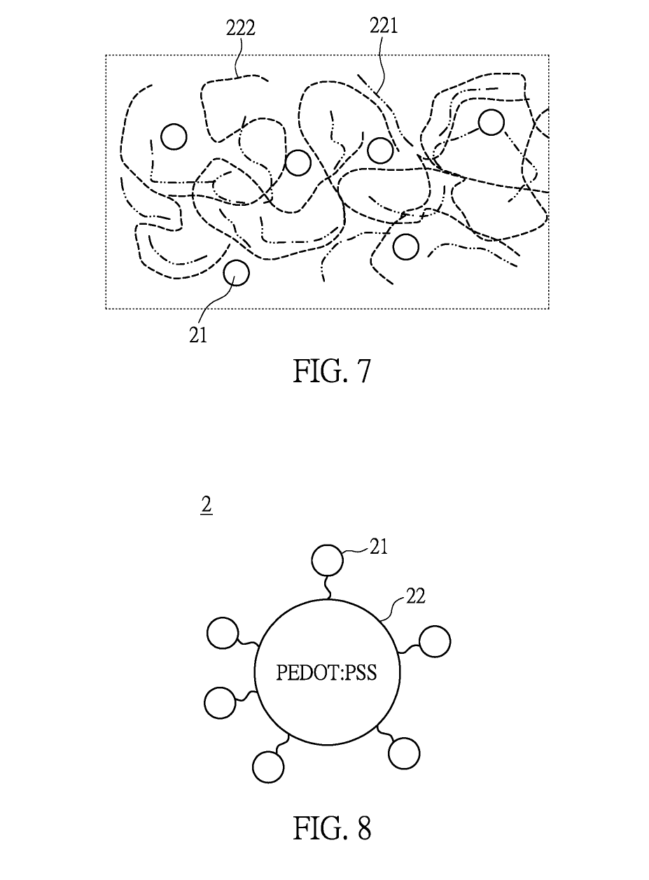

Reference is made to FIG. 7 and FIG. 8. As shown in FIG. 7, in step S102, the obtained polymer composite material 2 is formed by PEDOT, PSS and the emulsifier 21 (i.e., a PEDOT:PSS:emulsifier composite containing the PEDOT unit 221, the PSS unit 222 and the emulsifier 21). In another embodiment, in the polymer composite material 2, the PEDOT:PSS composite 22 is grafted by the emulsifier 21 (the emulsifier 21 covers 3,4-ethylenedioxythiophene and poly(styrenesulfonate)). However, the instant disclosure is not limited thereto. Therefore, the method for manufacturing a polymer composite material for a solid capacitor provided by the instant disclosure can provide a polymer composite material 2, and the polymer composite material 2 is formed by a polymerization process between PEDOT, PSS and the emulsifier 21.

It should be noted that in the instant disclosure, since the use of the emulsifier 21 before the polymerization reaction between 3,4-ethylenedioxythiophene and poly(styrenesulfonate) can effectively reduce the particle size of EDOT, the particle size of the polymer composite material 2 obtained after the polymerization reaction can be significantly reduced. The particle size of the polymer composite material 2 can be in the range of 1 to 25 nanometers. For example, compared to the material obtained by a polymerization reaction without the addition of the emulsifier 21 (which has a D50 average particle size of about 30 nm), the polymer composite material 2 obtained by the instant disclosure has a D50 average particle size of between 1 to 25 nm. Therefore, the conductive polymer layer formed by the polymer composite material 2 of the instant disclosure can have a better impregnation rate, thereby improving the capacitance of the capacitor.

In addition, it should be noted that the emulsifier 21 added before the polymerization reaction of the instant disclosure can not only achieve the effect of dispersing the polymer composite material 2 obtained by the polymerization reaction, but also increase the conductivity of the conductive polymer layer formed by the polymer composite material 2. In other words, the emulsifier 21 can provide the function of a dispersing agent and the function of a conductive co-agent, thereby improving the overall electrical property of the capacitor 1.

After the chemical reaction is completed, the polymer composite material 2 is dissolved in the suspension. After a centrifugation process, an ion-exchange process or a dialyser process for removing the salt ions remained in the suspension is performed, the suspension can be used directly as the material for forming the conductive polymer layer. The suspension can be formed on the cathode of the capacitor 1. For example, a film-formation process can be used to form the polymer composite material 2 on the cathode of the capacitor 1. Specifically, the capacitor element can be impregnated in a solution containing the polymer composite material 2 for forming the conductive layer on the surface of the capacitor.

In another embodiment, the suspension containing the polymer composite material 2 can be coated onto the electrolytic paper for adsorbing the suspension on the electrolytic paper (for example, permeating into the fibers of the electrolytic paper). The electrolytic paper can be used as the carrier of the conductive layer of the capacitor for maintaining the mechanical strength of the capacitor product.

In another embodiment, after step S102, the product stream containing the polymer composite material 2 can be purified for isolating the polymer composite material 2. Therefore, the purity of the polymer composite material 2 can be ensured. For example, at least one of a centrifugation process, a dialyser process, a column chromatography, a precipitation process and an ion-exchange process can be used to purify the product stream.

After the purifying step, the polymer composite material 2 can be homogeneously dispersed. For example, at least one of a homogeneous stirrer, an ultrasonic grinding machine, a high pressure homogenizer and a ball grinder can be used to homogeneously disperse the polymer composite material 2.

In addition, the instant disclosure provides a method for manufacturing a capacitor package structure including: providing at least a capacitor having a cathode portion using the polymer composite material manufactured according to the method mentioned above; and packaging the capacitor by a packaging structure, in which a positive pin and a negative pin both electrically connected to the capacitor are exposed from the packaging structure.

Reference is made to FIG. 2 and FIG. 4. The capacitor 1 can be the capacitor unit 42 in the stacked type solid electrolytic capacitor 4 or the winding-type component 31 in the winding-type solid state electrolytic capacitor 3. The packaging structure can be the packaging gel 43 of the stacked type solid electrolytic capacitor 4 or the packaging component 32 of the winding-type solid state electrolytic capacitor 3. The details of the components have been described above and are thus not reiterated herein.

In addition, the capacitor package structure formed by the polymer composite material 2 mentioned above includes at least a capacitor element, and the cathode portion of the capacitor element employs the polymer composite material 2 including the emulsifier 21, 3,4-ethylenedioxythiophene and poly(styrenesulfonate). The capacitor package using the polymer composite material 2 has been shown in FIG. 2 and FIG. 4, and the details thereof are thus not reiterated herein.

In summary, the advantages residing in the instant disclosure are that the instant disclosure including the technical features of “the polymer composite material including 3,4-ethylenedioxythiophene, poly(styrenesulfonate) and an emulsifier” can effectively increase the dispersing property of the polymer composite material 2 in a solvent, thereby reducing the particle size of the polymer composite material 2. Therefore, compared to the PEDOT:PSS polymer in the existing art, the polymer composite material 2 of the instant disclosure can fill into the corrosion holes on the surface of the electrodes, thereby increasing the capacitance of the capacitor 1 and improving the overall electrical property of the capacitor 1.

In addition, since the emulsifier 21 is included as a component for forming the polymer composite material 2, the polymer composite material 2 can have excellent dispersing property in the solvent. Therefore, mechanical-force-driven stirring is not necessary for the manufacturing process of the polymer composite material 2. Accordingly, the complexity and the cost of the manufacturing process can be reduced.

The above-mentioned descriptions represent merely the exemplary embodiment of the present disclosure, without any intention to limit the scope of the instant disclosure thereto. Various equivalent changes, alterations or modifications based on the claims of the instant disclosure are all consequently viewed as being embraced by the scope of the instant disclosure.

What is claimed is:

1. A method for manufacturing a polymer composite material for a solid capacitor, comprising:
adding an emulsifier, 3,4-ethylenedioxythiophene and poly(styrenesulfonate) into a solvent to form a mixture solution; and
initiating a chemical reaction between the emulsifier, 3,4-ethylenedioxythiophene and poly(styrenesulfonate) for forming the polymer composite material.

2. The method according to claim 1, wherein the emulsifier is selected from the group consisting of a polyol, hexadecyl trimethyl ammonium bromide, cetyltrimethylammonium bromide, dodecyltrimethylammonium bromide, polyethylene glycol monostearate, sodium dodecyl sulfate, sodium dodecylbenzenesulfonate, oleic acid and the derivatives thereof, glycerol monostearate, polyoxyethylene monooleate, poly(oxyethylene) (10) oleyl alcohol ether, sorbitan monolaurate, sorbitan monopalmitate, sorbitan monostearate, sorbitan tristearate, sorbiatan monooleate, sorbitan sesquiolate, sorbitan tribleate, polyoxyethylene oxypropylene oleate, polyoxyethylene sorbitol hexastearate, polyoxyethylene esters of mixed fatty acid and resin acids, polyoxyethylene sorbitol lanolin derivative, polyoxyethylene alkyl aryl ether, polyoxyethylene sorbitol beeswax derivative, polyoxyethylene monopalmitate, polyoxyethylene glycol monopalmitate, polyoxyethylene oxypropylene oleate, tetraethylene glycol monolaurate, polyoxyethylene monolaurate, polyoxyethylene lauryl ether, polyoxyethylene enemonooleate, hoxaethylene glycol monostearate, propylene glycol fatty acid ester, polyoxyethylene oxypropylene stearate, N-cetyl N-ethyl morpholinium ethosulfate, alkyl aryl sulfonate, polyoxypropylene stearate, polyoxyethylene laurylether, polyoxyethylene stearyl alcohol, diethylene glycol monolaurate, sorbitan monolaurate, sorbitan monopalmitate, ethylene glycol diglycidyl ether, polyethylene glycol diglycidyl ether, propanediol diglycidyl ether, polypropanediol diglycidyl ether, 1,2,3-propanetriol glycidyl ethers, and butanediol diglycidyl ether.

3. The method according to claim 2, wherein the emulsifier is a polyol.

4. The method according to claim 3, wherein the emulsifier is D-sorbitol, polyethylene glycol or polypropylene glycol.

5. The method according to claim 1, wherein the content of the emulsifier in the mixture solution is ranging from 20 to 30 wt. %.

6. The method according to claim 1, wherein the polymer composite material has an average particle size D50 ranging from 1 to 25 nanometers.

7. The method according to claim 1, wherein before the step of initiating the chemical reaction between the emulsifier, 3,4-ethylenedioxythiophene and poly(styrenesulfonate), further includes a step of adding an oxidant into the mixture solution.

8. A method for manufacturing a capacitor package structure including:
providing at least a capacitor having a cathode portion using the polymer composite material manufactured according to claim 1; and
packaging the capacitor by a packaging structure, wherein a positive pin and a negative pin both electrically connected to the capacitor are exposed from the packaging structure.

9. A polymer composite material for a cathode portion of a capacitor, wherein the polymer composite material includes 3,4-ethylenedioxythiophene, poly(styrenesulfonate) and an emulsifier, wherein the emulsifier encloses 3,4-ethylenedioxythiophene and poly(styrenesulfonate).

10. The polymer composite material according to claim 9, wherein the emulsifier is selected from the group consisting of a polyol, hexadecyl trimethyl ammonium bromide, cetyltrimethylammonium bromide, dodecyltrimethylammonium bromide, polyethylene glycol monostearate, sodium dodecyl sulfate polyacrylamide, sodium dodecylbenzenesulfonate, oleic acid and the derivatives thereof, glycerol monostearate, polyoxyethylene monooleate, poly(oxyethylene) (10) oleyl alcohol ether, sorbitan monolaurate, sorbitan monopalmitate, sorbitan monostearate, sorbitan tristearate, sorbiatan monooleate, sorbitan sesquiolate, sorbitan tribleate, polyoxyethylene oxypropylene oleate, polyoxyethylene sorbitol hexastearate, polyoxyethylene esters of mixed fatty and resin acids, polyoxyethylene sorbitol lanolin derivative, polyoxyethylene alkyl aryl ether, polyoxyethylene sorbitol beeswax derivative, polyoxyethylene monopalmitate, polyoxyethylene glycol monopalmitate, polyoxyethylene oxypropylene oleate, tetraethylene glycol monolaurate, polyoxyethylene monolaurate, polyoxyethylene lauryl ether, polyoxyethylene enemonooleate, hoxaethylene glycol monostearate, propylene glycol fatty acid ester, polyoxyethylene oxypropylene stearate, N-cetyl N-ethyl morpholinium ethosulfate, alkyl aryl sulfonate, polyoxypropylene stearate, polyoxyethylene laurylether, polyoxyethylene stearyl alcohol, diethylene glycol monolaurate, sorbitan monolaurate, sorbitan monopalmitate, ethylene glycol diglycidyl ether, polyethylene glycol diglycidyl ether, propanediol diglycidyl ether, polypropanediol diglycidyl ether, 1,2,3-propanetriol glycidyl ethers, and butanediol diglycidyl ether.

11. The polymer composite material according to claim 9, wherein the emulsifier is a polyol.

12. The polymer composite material according to claim 9, wherein 3,4-ethylenedioxythiophene is used as a conductive agent, poly(styrenesulfonate) is used as a dispersing agent and the emulsifier is used as a conductive agent and a dispersing agent, and the content of the emulsifier in the polymer composite material is ranging from 20 to 30 wt. %.

13. The polymer composite material according to claim 9, wherein the polymer composite material has an average particle size D50 ranging from 1 to 25 nanometers.

14. A capacitor package structure, including at least a capacitor, wherein a cathode portion of the capacitor employs the polymer composite material according to claim 9.
